(19) United States
(12) Patent Application Publication
(10) Pub. No.: US 2022/0391188 A1
(43) Pub. Date: Dec. 8, 2022

(54) SYSTEMS AND METHODS FOR CONTEXT-AWARE FIRMWARE UPDATE

(71) Applicant: Dell Products L.P., Round Rock, TX (US)

(72) Inventors: Ibrahim SAYYED, Georgetown, TX (US); Daniel L. HAMLIN, Round Rock, TX (US)

(73) Assignee: Dell Products L.P., Round Rock, TX (US)

(21) Appl. No.: 17/338,335

(22) Filed: Jun. 3, 2021

(51) Int. Cl. G06F 8/65; G06F 1/3206; H04L 12/24

(52) U.S. Cl. CPC G06F 8/65; G06F 1/3206; H04L 41/082

(57) ABSTRACT

An information handling system may include a power subsystem for supplying electrical energy to components of the information handling system, a power delivery interface configured to enable the power subsystem to draw power from a device external to the information handling system and communicatively coupled to the power delivery interface, a processor communicatively coupled to the power delivery interface, and a software service embodied in non-transitory computer-readable media and configured to, when read and executed by the processor, detect a configuration and context of the information handling system and in response to a request to perform a firmware update to the device, orchestrate power events of the information handling system and installation of the firmware update to the device based on the configuration and the context.

### TECHNICAL FIELD

The present disclosure relates in general to information handling systems, and more particularly to methods and systems for performing context-aware firmware updates to devices, particularly those devices from which an information handling system draws power, such as via a Universal Serial Bus (USB) Type-C Power Delivery (PD) connection.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Increasingly, information handling systems are utilizing USB Type-C PD to provide power to information handling systems via a device (e.g., a display monitor or docking station) coupled to the information handling system (e.g., in addition to or in lieu of traditional mechanisms for powering an information handling system, such as a battery or its own alternating current power source). However, such powering from a coupled device may lead to an increase in vulnerability to power loss by the information handling system during firmware management operations to the coupled device. Many firmware update procedures to a device may often require a power delivery subsystem of such device to be reset, introducing a risk of power loss by an information handling system coupled to and receiving power from the coupled device. If the information handling system has insufficient power provided from other sources (e.g., a battery or its own alternating current power source), the information handling system may lose power, potentially leading to power loss, which in turn may lead to data loss.

### SUMMARY

In accordance with the teachings of the present disclosure, the disadvantages and problems associated with firmware updates on devices configured to deliver power to a coupled information handling system may be reduced or eliminated.

In accordance with embodiments of the present disclosure, an information handling system may include a power subsystem for supplying electrical energy to components of the information handling system, a power delivery interface configured to enable the power subsystem to draw power from a device external to the information handling system and communicatively coupled to the power delivery interface, a processor communicatively coupled to the power delivery interface, and a software service embodied in non-transitory computer-readable media and configured to, when read and executed by the processor, detect a configuration and context of the information handling system and in response to a request to perform a firmware update to the device, orchestrate power events of the information handling system and installation of the firmware update to the device based on the configuration and the context.

In accordance with these and other embodiments of the present disclosure, a method may include, in an information handling system comprising a power subsystem for supplying electrical energy to components of the information handling system and a power delivery interface configured to enable the power subsystem to draw power from a device external to the information handling system and communicatively coupled to the power delivery interface, detecting a configuration and context of the information handling system and in response to a request to perform a firmware update to the device, orchestrating power events of the information handling system and installation of the firmware update to the device based on the configuration and the context.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, in an information handling system comprising a power subsystem for supplying electrical energy to components of the information handling system and a power delivery interface configured to enable the power subsystem to draw power from a device external to the information handling system and communicatively coupled to the power delivery interface, detect a configuration and context of the information handling system and in response to a request to perform a firmware update to the device, orchestrate power events of the information handling system and installation of the firmware update to the device based on the configuration and the context.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system comprising an information handling system and a display device, in accordance with embodiments of the present disclosure; and

FIGS. 2A and 2B (which may be referred to collectively herein as “FIG. 2”) illustrate a flow chart of an example method for orchestration of a context-aware firmware update, in accordance with embodiments of the present disclosure.

### DETAILED DESCRIPTION

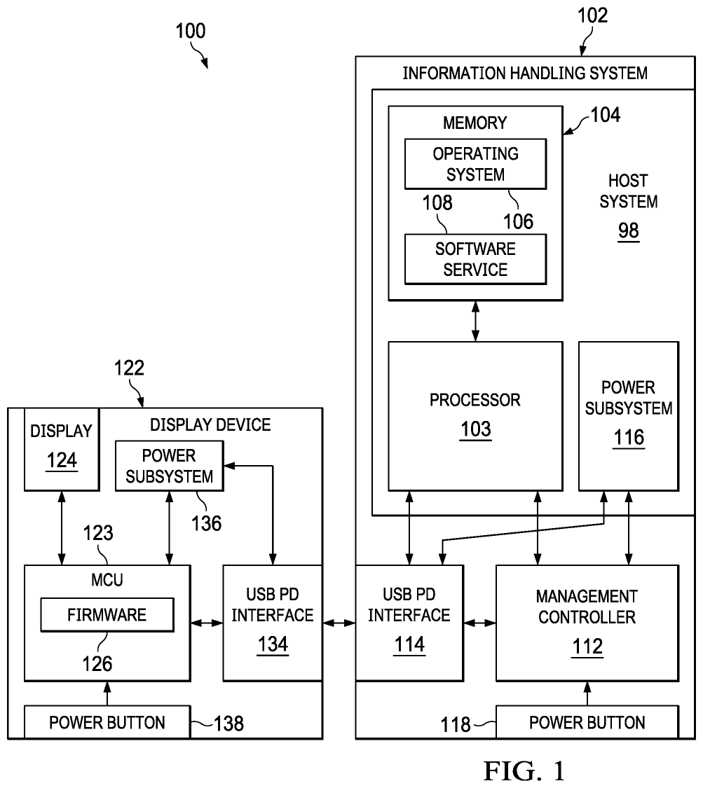

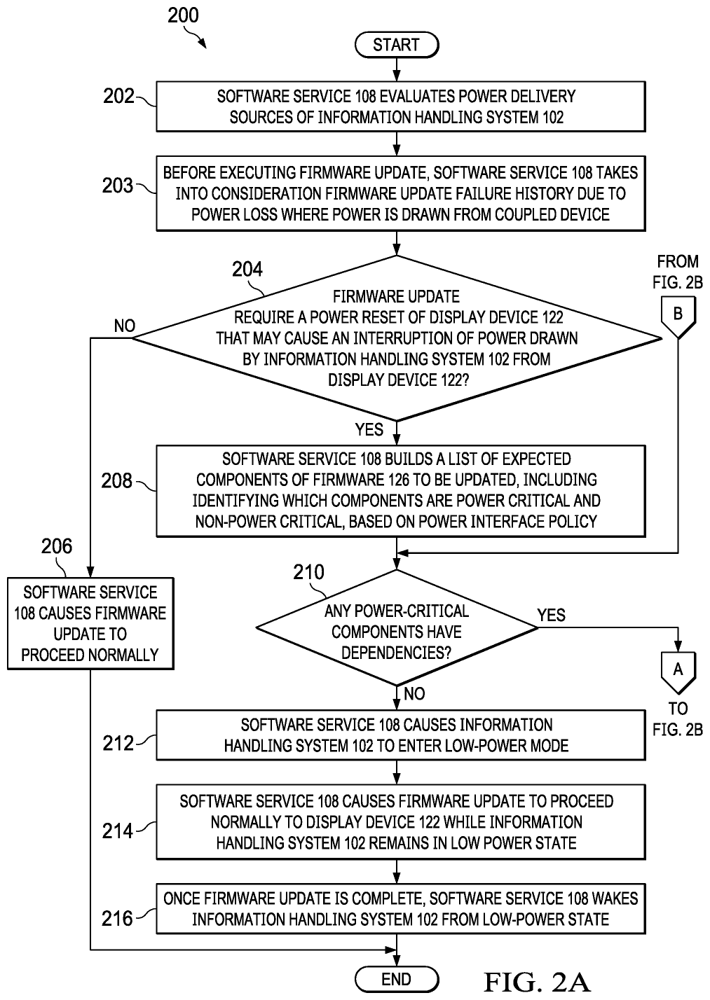

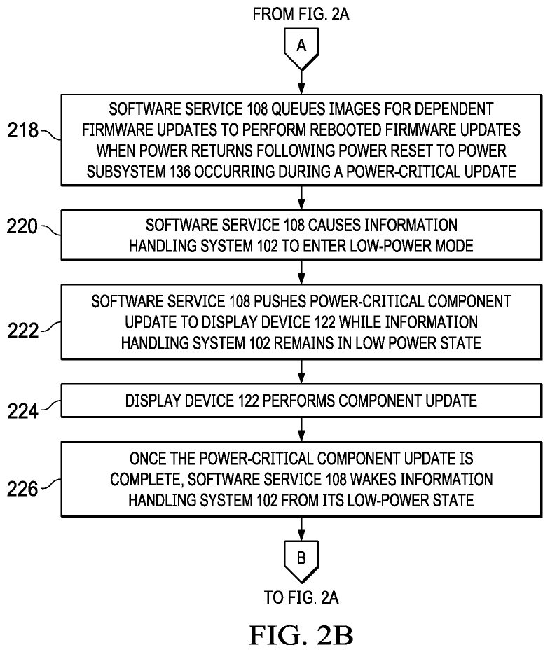

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 comprising an information handling system 102 and a display device 122, in accordance with embodiments of the present disclosure. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a management controller 112 communicatively coupled to processor 103, a Universal Serial Bus (USB) Power Delivery (PD) interface 114 communicatively coupled to processor 103 and management controller 112, a power subsystem 116 communicatively coupled to management controller 112, and a power button 118 communicatively coupled to management controller 112. In operation, processor 103 and memory 104 may comprise at least a portion of a host system 98 of information handling system 102.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

As also shown in FIG. 1, memory 104 may have stored thereon a software service 108. Software service 108 may comprise any program of executable instructions, or aggregation of programs of executable instructions, configured to provide a managed and instrumented upgrade to one or more devices coupled to information handling system 102. For example, as described in greater detail below, software service 108 may be configured to detect a system configuration for information handling system 102 and a context for information handling system 102 (e.g., power delivery status, power consumption rate, firmware update power priority policy, firmware update failure policy, etc.) and dynamically cause information handling system 102 to enter into a low power state to facilitate firmware update during runtime to a coupled device from which the information handling system draws power, to ensure likelihood of success of the firmware update to the device and reduce the risk of power loss to the information handling system. In some embodiments, software service 108 may execute “on top of” operating system 106. In operation, active portions of software service 108 may be transferred to memory 104 for execution by processor 103. Although software service 108 is shown in FIG. 1 as stored in memory 104, in some embodiments software service 108 may be stored in storage media accessible to processor 103, and active portions of software service 108 may be transferred from such storage media to memory 104 for execution by processor 103.

Management controller 112 may be configured to provide management facilities for management of information handling system 102. Such management may be made by management controller 112 even if information handling system 102 is powered off or powered to a standby state. Management controller 112 may include a processor, a memory, and other components, such as USB PD interface 114. In certain embodiments, management controller 112 may include or may be an integral part of an embedded controller (EC), baseboard management controller (BMC), or a remote access controller (e.g., a Dell Remote Access Controller or Integrated Dell Remote Access Controller).

USB PD interface 114 may comprise any suitable system, device, or apparatus configured to serve as a cable interface in accordance with the USB PD specification. Although FIG. 1 depicts a USB PD interface 114, in some embodiments, an analogous data communication interface in accordance with a different communication standard may be used. In these and other embodiments, USB PD interface 114 may be communicatively coupled to management controller 112 via an Inter-Integrated Circuit (I2C) communications bus. In some embodiments, power subsystem 116 may be able to draw power from display device 122 via USB PD interface 114 and USB PD interface 134.

Power subsystem 116 may comprise any suitable system, device, or apparatus configured to deliver electrical energy to one or more components of information handling system 102 in order to allow such components to function. Accordingly, power subsystem 116 may include any suitable combination and number of power supply units, energy storage devices (e.g., batteries), regulators, and electrical conduits (e.g., wires, traces).

Power button 118 may comprise any suitable system, device, or apparatus with which a user may interact to indicate a desire to power on or power off information handling system 102. Accordingly, power button 118 may comprise an electromechanical button, a virtual mechanical button, or any other suitable device.

In addition to processor 103, memory 104, management controller 112, USB PD interface 114, power subsystem 116, and power button 118, information handling system 102 may include one or more other information handling resources. In addition, although FIG. 1 shows information handling system 102 configured as what many would consider a computing system, in some embodiments, information handling system 102 may include fewer components than that often seen in a computing system, and may comprise a device with less functionality, such as a docking station or port replicator.

As depicted in FIG. 1, display device 122 may include a microcontroller unit (MCU) 123, a display 124 communicatively coupled to MCU 123, a USB PD interface 134 communicatively coupled to MCU 123, a power subsystem 136 communicatively coupled to MCU 123, and a power button 138 communicatively coupled to MCU 123.

MCU 123 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data.

As shown in FIG. 1, MCU 123 may include firmware 126. Firmware 126 may comprise specialized software that provides the low-level control for a display device 122's specific hardware. For example, such firmware may include elementary basic functions for carrying out functionality of display device 122. As another example, firmware 126 may perform some or all of the control, monitoring, and data manipulation functions for display device 122.

Display 124 may include any system, device, or apparatus configured to generate graphical images and/or reproduce alphanumeric text for viewing by a user of information handling system 102, based on display data communicated to display 124 from information handling system 102. Display 124 may comprise a light-emitting diode display, liquid crystal display, and/or any other suitable display.

USB PD interface 134 may comprise any suitable system, device, or apparatus configured to serve as a cable interface in accordance with the USB PD specification. Although FIG. 1 depicts a USB PD interface 134, in some embodiments, an analogous data communication interface in accordance with a different communication standard may be used. In operation, USB PD interface 134 may be coupled to USB PD interface 114 by a suitable cable (e.g., a USB Type-C cable).

Power subsystem 136 may comprise any suitable system, device, or apparatus configured to deliver electrical energy to one or more components of display device 122 in order to allow such components to function. Accordingly, power subsystem 136 may include any suitable combination and number of power supply units, energy storage devices (e.g., batteries), regulators, and electrical conduits (e.g., wires, traces).

Power button 138 may comprise any suitable system, device, or apparatus with which a user may interact to indicate a desire to power on or power off display device 122. Accordingly, power button 138 may comprise an electromechanical button, a virtual mechanical button, or any other suitable device.

For clarity of exposition, FIG. 1 depicts only a single display device 122 communicatively coupled to information handling system 102. However, in some embodiments of system 100, system 100 may include a plurality of display devices 122 communicatively coupled to information handling system 102 (e.g., directly to information handling system 102 or in a daisy chain from display device 122 to display device 122).

In operation, software service 108 may perform managed and instrumented upgrade of a firmware update to display device 122. For example, software service 108 may detect a system configuration of information handling system 102 and a context for information handling system 102. Such context may include any suitable information regarding power subsystem 116 of information handling system 102 and/or information regarding a firmware update to be applied to display device 122. Examples of such context may include power consumption rates of information handling system 102, power delivery mechanisms associated with information handling system 102 (e.g., battery state of information handling system 102, whether information handling system 102 is powered through other Type-C devices, whether information handling system 102 is coupled to another alternating current power source, etc.), firmware update policies, firmware update dependencies, and history of firmware update failure due to power loss. Based on such configuration and context, software service 108 may determine whether to proceed with a firmware update to firmware 126 of display device 122. If software service 108 determines to proceed with the firmware update to firmware 126, software service 108 may then create an installation routine order and orchestrate the firmware update.

Orchestration may including reading policy requirements from payloads of firmware updates to ensure power requirements are met. For example, a firmware update may include, in addition to a payload of updated firmware, a policy for the firmware update, including a power interface policy. Such power interface policy may include, without limitation, whether an update is power critical or non-critical, whether an alternating current power source is required for the firmware update or whether a Type-C PD power source is acceptable, and an estimated time duration of the firmware update.

As part of orchestration, software service 108 may also detect a power delivery status for information handling system 102 and dynamically enter a low power state to increase likelihood of success of the firmware update, and then may resume automatically from the lower power state to a normal power state upon completion of the firmware update. Further during orchestration, software service 108 may apply a firmware update on power critical devices first and also prepare information handling system 102 for queuing and pushing a firmware load to display device 122 to perform a rebooted firmware update upon power loss occurring during a firmware update. Once power-critical updates are complete, software service 108 may cause non-power critical firmware updates to be applied. If power loss occurs in the middle of a non-power critical update, such update process may resume upon return of power.

FIG. 2 illustrates a flow chart of an example method 200 for orchestration of a context-aware firmware update, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

In particular, method 200 may comprise an installation routine for an update of firmware 126 to display device 122 coupled to information handling system 102 having no battery and powered from display device 122 via USB PD interface 114 and USB PD interface 134. Step 202 may begin after the detection of configuration and context and the subsequent creation of an installation routine, as described above.

At step 202, software service 108 may evaluate power delivery sources (e.g., alternating current (AC) sources only, AC through Type-C PD, etc.) of information handling system 102.

At step 203, before executing the firmware update, software service 108 may take into consideration firmware update failure history due to power loss where power is drawn from a coupled device (e.g., display device 122).

At step 204, based on the detected context of information handling system 102 and the evaluation of power delivery sources, software service 108 may determine whether a firmware update requires a power reset of display device 122 that may cause an interruption of power drawn by information handling system 102 from display device 122. If the firmware update requires a power reset of display device 122, method 200 may proceed to step 208. Otherwise, method 200 may proceed to step 206.

At step 206, software service 108 may cause the firmware update to proceed normally. After completion of step 206, method 200 may end.

At step 208, software service 108 may build a list of expected components of firmware 126 to be updated, including identifying which components are power critical and non-power critical, based on power interface policy.

At step 210, software service 108 may determine whether any of the power-critical components have dependencies. If one or more power-critical components have dependencies, method 200 may proceed to step 218. Otherwise, method 200 may proceed to step 212.

At step 212, software service 108 may cause information handling system 102 to enter a low-power mode (e.g., the S4 or S5 sleep states pursuant to the Advanced Configuration and Power Interface (ACPI) specification). At step 214, software service 108 may cause the firmware update to proceed normally to display device 122 while information handling system 102 remains in the low power state. At step 216, once the firmware update is complete, software service 108 may wake information handling system 102 from its low-power state. After completion of step 216, method 200 may end.

At step 218, software service 108 may queue images for dependent firmware updates to perform rebooted firmware updates when power returns following a power reset to power subsystem 136 occurring during a power-critical update.

At step 220, software service 108 may cause information handling system 102 to enter a low-power mode (e.g., the S4 or S5 sleep states pursuant to the Advanced Configuration and Power Interface (ACPI) specification). At step 222, software service 108 may push the power-critical component update to display device 122 while information handling system 102 remains in the low power state. At step 224, display device 122 may perform the component update.

At step 226, once the power-critical component update is complete, software service 108 may wake information handling system 102 from its low-power state. After completion of step 226, method 200 may proceed again to step 210, where portions of method 200 may again execute to complete installation of all other components of the firmware update.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using display device 122, MCU 123, and/or any other system operable to implement method 200. In certain embodiments, method 200 may be implemented partially or fully in software and/or firmware embodied in computer-readable media.

Although the foregoing contemplates a context-aware firmware update occurring on a display device 122 from which information handling system 102 is powered, it is understood that the systems and methods may be similarly applied to a firmware update to any device from which an information handling system may draw power via a power delivery interface, including without limitation a USB Type-C PD interface. Examples of such devices may include a docking station, which also may be referred to as a port replicator.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a power subsystem for supplying electrical energy to components of the information handling system;
a power delivery interface configured to enable the power subsystem to draw power from a device external to the information handling system and communicatively coupled to the power delivery interface;
a processor communicatively coupled to the power delivery interface; and
a software service embodied in non-transitory computer-readable media and configured to, when read and executed by the processor:
detect a configuration and context of the information handling system; and
in response to a request to perform a firmware update to the device, orchestrate power events of the information handling system and installation of the firmware update to the device based on the configuration and the context.

2. The information handling system of claim 1, wherein the device comprises a display device.

3. The information handling system of claim 1, wherein the device comprises a docking station.

4. The information handling system of claim 1, wherein the context includes one or more of power consumption rates associated with the information handling system and power delivery mechanisms for delivering electrical energy to components of the information handling system.

5. The information handling system of claim 1, wherein the context includes one or more of firmware update policies, firmware update dependencies, and a history of firmware update failures due to power loss.

6. The information handling system of claim 1, wherein orchestrating includes:
determining based on the context whether the firmware update is likely to cause a power reset of a power subsystem of the device causing the device to cease delivering electrical energy to the information handling system; and
causing the information handling system to enter a low-power state during installation of the firmware update is likely to cause a power reset of the power subsystem of the device causing the device to cease delivering electrical energy to the information handling system.

7. The information handling system of claim 1, wherein orchestrating includes ordering installation of components of the firmware update based on dependencies of the components of the firmware update and whether such components are power critical.

8. A method comprising, in an information handling system comprising a power subsystem for supplying electrical energy to components of the information handling system and a power delivery interface configured to enable the power subsystem to draw power from a device external to the information handling system and communicatively coupled to the power delivery interface:
detecting a configuration and context of the information handling system; and
in response to a request to perform a firmware update to the device, orchestrating power events of the information handling system and installation of the firmware update to the device based on the configuration and the context.

9. The method of claim 8, wherein the device comprises a display device.

10. The method of claim 8, wherein the device comprises a docking station.

11. The method of claim 8, wherein the context includes one or more of power consumption rates associated with the information handling system and power delivery mechanisms for delivering electrical energy to components of the information handling system.

12. The method of claim 8, wherein the context includes one or more of firmware update policies, firmware update dependencies, and a history of firmware update failures due to power loss.

13. The method of claim 8, wherein orchestrating includes:
determining based on the context whether the firmware update is likely to cause a power reset of a power subsystem of the device causing the device to cease delivering electrical energy to the information handling system; and
causing the information handling system to enter a low-power state during installation of the firmware update is likely to cause a power reset of the power subsystem of the device causing the device to cease delivering electrical energy to the information handling system.

14. The method of claim 8, wherein orchestrating includes ordering installation of components of the firmware update based on dependencies of the components of the firmware update and whether such components are power critical.

15. An article of manufacture comprising:
a non-transitory computer-readable medium; and
computer-executable instructions carried on the computer-readable medium, the instructions readable by a processor, the instructions, when read and executed, for causing the processor to in an information handling system comprising a power subsystem for supplying electrical energy to components of the information handling system and a power delivery interface configured to enable the power subsystem to draw power from a device external to the information handling system and communicatively coupled to the power delivery interface:
detect a configuration and context of the information handling system; and
in response to a request to perform a firmware update to the device, orchestrate power events of the information handling system and installation of the firmware update to the device based on the configuration and the context.

16. The article of claim 15, wherein the device comprises a display device.

17. The article of claim 15, wherein the device comprises a docking station.

18. The article of claim 15, wherein the context includes one or more of power consumption rates associated with the information handling system and power delivery mechanisms for delivering electrical energy to components of the information handling system.

19. The article of claim 15, wherein the context includes one or more of firmware update policies, firmware update dependencies, and a history of firmware update failures due to power loss.

20. The article of claim 15, wherein orchestrating includes:
determining based on the context whether the firmware update is likely to cause a power reset of a power subsystem of the device causing the device to cease delivering electrical energy to the information handling system; and
causing the information handling system to enter a low-power state during installation of the firmware update is likely to cause a power reset of the power subsystem of the device causing the device to cease delivering electrical energy to the information handling system.

21. The article of claim 15, wherein orchestrating includes ordering installation of components of the firmware update based on dependencies of the components of the firmware update and whether such components are power critical.
